(19) United States
(12) Patent Application Publication
(10) Pub. No.: US 2003/0212684 A1
(43) Pub. Date: Nov. 13, 2003

(54) System and method for adapting preferences based on device location or network topology

(76) Inventors: Markus Meyer, Winsen/Luhe (DE); Venkatachary Srinivasan, Sunnyvale, CA (US)

Correspondence Address: Pennie & Edmonds, LLP, 3300 Hillview Avenue, Palo Alto, CA, 94304, US

(21) Appl. No.: 10/384,225

(22) Filed: Mar. 7, 2003

Related U.S. Application Data
(60) Provisional application No. 60/363,810, filed on Mar. 11, 2002.

(51) Int. Cl. G06F 7/00

(52) U.S. Cl. 707/10

(57) ABSTRACT

A method of remotely modifying a current configuration of an electronic device, which affects at least one function of the electronic device. The method determines, at the electronic device, a changed external circumstance, and then transmits an indication of the changed external circumstance, associated with the electronic device, to a remote server. Next, the method receives, at the remote server, the indication of the changed external circumstance associated with the electronic device. Additionally, the method determines, from a computer database, a modified configuration appropriate to the electronic device, based at least in part on the changed external circumstance. The method then transmits the modified configuration from the remote server to the electronic device, and receives, at the electronic device, the modified configuration. Finally, the method updates the current configuration of the electronic device with the modified configuration, which affects at least one function of the electronic device.

### RELATED APPLICATIONS

This application claims priority to, and incorporates herein by reference, an application entitled “SYSTEM AND METHOD FOR ADAPTING PREFERENCES BASED ON DEVICE LOCATION OR NETWORK TOPOLOGY,” filed on Mar. 11, 2002, and identified by serial No. 60/363,810 and attorney docket number 11114-004-888.

This application is related to, and incorporates herein by reference, an application entitled “SYSTEM AND METHOD FOR MANAGING A PLURALITY OF ELECTRONIC DEVICES,” filed on Mar. 11, 2002, and identified by serial No. 60/363,802 and attorney docket number 11114-003-888; “SYSTEM AND METHOD FOR DELIVERING DATA IN A NETWORK,” filed on Mar. 11, 2002, and identified by serial No. 60/363,877 and attorney docket number 11114-005-888; and “SYSTEM FOR STANDARDIZING UPDATES OF DATA ON A PLURALITY OF ELECTRONIC DEVICES,” filed on Mar. 11, 2002, and identified by serial No. 60/363,876 and attorney docket number 11114-006-888.

### FIELD OF THE INVENTION

The present invention relates generally to the communication of data to handheld devices and relates particularly to a system and method for remotely configuring electronic devices based on external device circumstances like geographic location and network topology.

### BACKGROUND

### General State of the Art

The recent proliferation of electronic devices for recreation, information management and communication has taken routine computing power far away from the desk-bound personal computer. People in all walks of life are using such devices in the home, in the office, in factories, out in the field, and on the road. There are a diverse range of possible applications of such devices, including communication, business, navigation, entertainment, and even the management of basic household chores. The innovation rate continues to accelerate at a rapid pace—driven by end-user demand and the proliferation of new devices, standards, and protocols. Whereas today many users only access a single device for a single task, in the foreseeable future, users will want multiple functionality across many devices in their possession.

Although devices in use and those that can be envisaged come in all shapes and sizes, they present similar challenges for the people who make them and for the providers who offer services for them. This is because there are many attributes the devices share. Inside a typical device can be found hardware, and, interfacing with the user, the devices utilize various software components and often a complex operating system. Accordingly, there is potential for a single comprehensive infrastructure to be developed to enable a plethora of such devices to be upgraded, configured, and managed in a standardized manner. With standardization comes a greater desirability, reliability, and interoperability to meet the ever-increasing demands of end users.

Although cell phones, personal digital assistants, game stations, and car navigation systems are being used by a steadily increasing population of users, the level of user sophistication is not increasing significantly. Customers prefer to avail themselves of the advanced features of these devices without wanting the effort of configuring each new device for themselves. The user community is evolving into one that wants to take an idea, such as a list of frequently-dialed numbers, from one device to another but does not want to be distracted by the operating details of every device, nor the logistical complication of ensuring maximum consistency in their own data on all the available devices.

Furthermore, devices now becoming available are rarely single-function devices. Increasing the number of functions of a device only increases the level of personalization that is possible. Correspondingly, users are coming to expect unified access to their own data wherever they are —independent of what device they are using or what service they are connected to. Ideally, access to data should not depend on a user's location, as determined by which network a user has “roamed” into.

Accordingly, common problems associated with a world populated with a multitude of individual devices include: updating functionality on devices after sale, and preserving user-specific settings when coping with changes of location or device. These problems are preferably addressed by the companies that provide services and those that supply the devices rather than by the individual users. End users merely want devices that are easy to use, reliable, and enhanceable in a straightforward way.

Traditional service providers as well as large organizations such as airlines, banks, and a vast number of other enterprises, offer services to their customers and end users through devices. They want to increase their revenue from both existing and new services. They need to adopt ever more flexible ways of retaining existing customers and attracting new ones while continuing to add more services.

Device manufacturers want to upgrade existing devices with new software components more efficiently, and replace existing devices with new devices in such a way that time is not lost in transferring over a user's settings. The simpler it becomes for end users to upgrade and extend their usage, the more likely it is that those end users will buy new devices more frequently. Device manufacturers are also vying to sell additional devices to their installed customer base, for example a complex cell phone for business use and a simpler one for personal use. Along with service providers, device manufacturers want the flexibility to add new services, even to existing devices.

Thus, to successfully deploy, service, and maintain a plethora of devices, service providers and device manufacturers must be able to update them and add functionality to them after they have been sold. Such a capability not only preserves data, thereby enhancing its value to the user, but may also extend a device's useful lifetime. But such a task is complex not just because of the number of different types of devices currently available but because of the burgeoning number of individual users. Although a pair of devices may be identical, no two users are alike. So, vendors must get not just data to and from the device, but they must ensure user-specific or location-specific preferences are updated or maintained from one device to another, including when devices are replaced or upgraded. In short, vendors need flexible software component management, robust data management, and effective preference/configuration management.

Ultimately, then, end users want more device choices, more freedom to control preferences, more access to their data, and more personalization. At the same time, end users also want less hassle, less time spent reconfiguring preferences, and fewer worries about access to personal preferences while roaming and upgrading. Service providers want to be able to obtain more revenue from existing and new services, greater levels of customer retention, and more ways to improve the customer relationship. To achieve this, service providers want to minimize the overheads and time associated with deploying device upgrades, and want to spend less time on activities that are beyond their area of expertise. Device manufacturers want to be able to easily upgrade existing devices, sell more devices, and offer more services to gain a competitive advantage. Such gains will serve to optimize the product-development cycle time.

### End User Expectations

Specific problems associated with personal devices such as cell phones are that end-users do not want to be troubled with the need to reset preferences every time they roam into a different network. Similarly, when upgrading an existing phone or purchasing a second phone, the user does not want to reset their preferences from scratch and reenter a phone book. Such personal trends run up against the technological trend that cell phones, for example, are getting more powerful with an increasing number of features that require either the end user or a service provider to configure.

With a large number of options such as SMS, MMS, wireless internet (WAP), fast internet access, “Bluetooth” connectivity, SyncML, transparent access to data such as e-mail, contacts, and calendar—even delivered through a corporate firewall, personalized ring tones and melodies, greater freedom to roam, and many others, cell phones are far from being fixed-function devices. Service providers and device manufacturers have to provide the appropriate device and preference functionality because users continue to demand more of their mobile devices.

Furthermore, the next generation of cell phones will be enhanced with PalmOS, Symbian, J2ME, WindowsCE, and other similar advanced operating systems to let service providers and end users download new software modules on their own. Similarly, personal digital assistants (PDA's) will have “Bluetooth”, infrared, wireless Ethernet (802.11a, 802.11b or 802.11g), or other connections to communicate with other electronic devices and to enable wireless access to the Internet and other networks from the PDA. Users will expect automatic configuration, so they simply achieve seamless access when they connect. Accordingly, software component management, data management, and preference/configuration management will become vital to make this efficient.

Correspondingly, the next generation of screen phones—whether based on traditional analog/digital circuit switched technology, or VoIP packet-switch technology—will offer an enhanced set of services that offer much more than a phone call. It is anticipated that end users will have access to voice and video conferencing while checking e-mail, contacts, calendar, stock quotes, news, and weather. Clearly, when presented with so many options, swift and easy upgrade of data and preferences will be desirable, if not essential.

Entertainment devices provide another arena in which standardization of upgrades and user preferences is likely to become important. Users of game consoles want to connect with a community of players so that they can compete, post scores, get hints and tips while playing, read game reviews, and generally share their experiences with other players around the world. Constant upgrades to game software and devices will be needed to satisfy these end users. But they will not be satisfied if they have to perform the upgrades themselves.

Similarly, televisions, set-top devices, personal video recorders, digital audio players such as MP3 players, and home audio systems have become devices with greatly enhanced functionality—including the ability to communicate with one another. The home entertainment center will soon comprise a number of separate but connected devices, enabling a variety of digital media to be shared throughout the house and among friends. The number of device upgrades required to achieve such a level of connectivity is likely to be more than any end user will be willing to make.

Many devices currently available can be referred to as “productivity devices.” For example, car navigation systems are already in widespread use. Car command centers can soon expect to be able to alert drivers to real-time traffic and construction delays. Plus, the ability to access e-mail, calendar, and address book from an in-car device will assist in improving productivity even when on the move. Even so, such facilities will benefit from transparent synchronized updates of individual users' preferences and data.

Internet terminals and “web pads” will, before long, offer very easy ways to perform standard functions such as internet browsing, e-mail transmission, calendar, as well as provide basic document creation tools such as word processors and spreadsheets. These systems and other systems with similar capabilities will serve as enhancements or extensions to PC's, without actually replacing PC's but will benefit enormously from synchronized update of preferences.

Daily life is also becoming more and more influenced by a category of devices known as “controller devices,” for example, cable routers, high-end appliances such as refrigerators, and alarm systems. Such devices typically take two forms: they are either the unseen black boxes that control certain critical daily functions; or they are the part of larger appliances that give the user functionality control. In both cases, these devices are converging towards other electronic devices in their capabilities, are becoming connected to the rest of the digital world and are communicating with other like devices. This convergence presents a challenge to service providers and device manufacturers not only because of the software management required, but also because these controllers have very long life cycles. With these long life cycles comes the need to enhance the controller devices while they are in use.

Today, these devices are hardware-intensive products that supply a single function. But as with personal devices, they are becoming more service-driven. Telemetry is one technology that allows the shift from product/device to product/service. Telemetry is a growing trend across a variety of devices that enables vendors to determine and analyze problems on working devices, fix the problems, and make adjustments to prevent the problems from recurring. As these devices get more user-specific and in need of constant upgrades, their complexity increases and the likelihood that they will benefit from a means for simplifying the upgrade process also increases. Telemetry is already being seen in cars, airplanes, and elevators today. Its application is likely to spread to phones, alarm systems, and “white goods” appliances.

In essence, people are wanting increasing levels of control, preferably from any where, on any device. Whether it is to control what their children can and cannot access on the internet and view on television or whether they want to control when their heater turns on and off, such levels of control require complex software component management, data management, and preference/configuration management.

Many household appliances, such as refrigerators, dishwashers, ovens, and washing machines, have not required network connections or software modules hitherto. In the future, the refrigerator, for instance, will be smart enough to monitor its own contents. But, in general, people simply want to buy a refrigerator that will be reliable and will last. Vendors, then, must somehow retain a customer relationship throughout a long product life cycle, so customers will want to purchase add-on services and retain brand loyalty. Using telemetry, service providers or device manufacturers can monitor devices such as a refrigerator, send data to their servers, analyze the data, modify the software, and prevent future problems. In a similar way, the car controller system monitoring the engine, fuel pump, etc., is not only interacting through the dashboard with the driver, but also can communicate with a service technician in real time.

This approach is far more cost-effective than sending a service technician out to the home each month to do the monitoring. In order for this monitoring to be carried out centrally and to be able to provide more comprehensive usage information, it would be useful to be able to update the state of the device easily. Such a capability would also benefit end users, who can have the same information at their disposal.

Communication controllers such as routers are specific devices for which end users and service providers both want more functionality, including features such as firewall, virtual private network, parental controls, anti-virus protection, and other services. The devices have got to run all the time, be secure, and enable access from any where, on any device. End users prefer the simplest interface possible, for example, selecting an internet service provider or paying a monthly fee, without worrying about its maintenance. That leaves the regular upgrading of the firewall, virtual private network, parental controls, and anti-virus protection to the service provider. The service provider would also like to monitor the device itself. For all of these tasks, the preference/configuration management and data delivery management demands are immense.

Phone system users in the home and in business want features such as conferencing, unified messaging, voice mail, routing, and forwarding without wanting to spend inordinate amounts of time setting preferences. They also want personalized features such as ring tones, melodies, and a specified number of rings before the phone switches to voice mail. And they expect their preferences to remain the same whether they upgrade or replace a device, or want to tie-in with their other devices. Organizations want to audit phone usage in order to negotiate better rates. Service providers and device manufacturers want to offer these services while monitoring reliability and usage. Basically, this is complex and difficult to manage with existing technologies.

The home or residential gateway is the single point where users connect all their communication systems, entertainment systems, alarm systems, heating and ventilation systems, and Instabus/X10 electrical systems. New standards for monitoring, controlling, and unifying these gateways are arising so users can turn on the house lights as they pull into the driveway, adjust the heat using their cell phone so it is ideal when they arrive, and check the status of all their systems while they are on vacation. The proliferation of new devices is nearly matched by the number of new protocols—resulting in a preference/configuration challenge for service providers and device manufacturers.

There has been a proliferation of wireless standards from 802.11a, 802.11b, and 802.11g to “Bluetooth” and HomeRF protocols. With multiple access points throughout the home or office, users add not only PC's but also PDA's, Web pads, and entertainment devices after the fact. Aside from the obvious compatibility problems, there is the matter of security: no one wants their neighbor or competitor using their wireless access points. Since end users do not want to manage and upgrade the device themselves, the responsibility falls to the service providers or device manufacturers to handle these complex demands.

Instabus or X10 systems must communicate with sensors and switches and aggregate a variety of devices. And a single alarm system must work with multiple monitoring devices-motion sensors, door and window sensors, glass-breaking sensors—and be accessed and operated from any where. The need for software component management, data management, and preference/configuration management is substantial.

In most large organizations, certain devices have to be up and running continuously. Planned downtime must be kept to a bare minimum. Unplanned downtime has severe negative consequences. This presents an enormous challenge to organizations because these devices are often in distant locations. Such devices must be centrally administered and managed—and the ability to update to new models while existing devices continue to be deployed is vital. These tend to be single-model devices, which means that any change affects a great number of devices. Thus, the organization's economic efficiency depends upon the way it manages these devices. Such devices are often referred to as “Vertical Solution” devices.

Organizations, service providers, and device manufacturers have been creating vertical solution devices such as banking terminals, cash registers, and industrial controllers for years. But the above challenges have forced them to commit precious time and resources to building homegrown solutions for device, preferences, and data management, which is not their core area of expertise.

From self-service terminals and dialog terminals to machine controllers, industry-specific devices are deployed by organizations and operated by customers or employees who may not be technically savvy. Ease of use and reliability are critical, because these devices are essential to the well-being of the organization. They play a key role in customer satisfaction, product and service delivery time, and overall productivity.

Banking terminals are examples of self-service terminals that originally provided customers the ability to deposit and withdraw money. As with all other computing devices, the functionality and features of these terminals continue to grow. Each branch wants to offer its own promotions and serve customers in a more personalized fashion. Location-based services—even non-banking services—greatly enhance the customer experience while directly benefitting the organization. Branches can target promotions depending on a customer's net worth. Or, they can base offers on whatever the interest rate happens to be on that given day. This requires continuous two-way communication with headquarters, so corporate data must be accessed and sent immediately. And if the terminal is not operating, it has a significant effect on customer satisfaction, which directly affects customer loyalty.

Check-in terminals are fast becoming a familiar sight in airports, rental car agencies, and at events such as movies and concerts. They need to be simple, because the end user does not want to read complicated instructions just to get tickets. They must also be reliable, because their purpose is to decrease the time spent in line and enhance customer satisfaction. The devices' feature sets must be able to change seamlessly and be easily customized so that airlines, for instance, can target promotions toward frequent fliers or alter promotions quickly as demands change.

Large chain stores and restaurants—and even some individually owned establishments—feature rather sophisticated cash registers, as well as other examples of “dialog terminals.” These devices are constantly altered to account for new products, prices, and customer-loyalty promotions. They also must accommodate ever-changing connectivity with bar-code and credit-card readers. And they must also be easily self-serviced by employees who have not been trained with the requisite computing skills.

Mobile data units are used by delivery companies such as Federal Express and United Parcel Service, transportation providers, rental car companies, and field-service personnel to improve customer satisfaction and productivity through two-way connectivity to headquarters. On the road, on the train, in the hospital, or at the construction site, these devices help keep people connected. This requires flexible connectivity—for example, Bluetooth on the road and Wi-Fi (e.g., 802.11b) at the home base. It is desirable for these devices to be seamlessly upgraded in real time, thereby extending the product life cycle.

Finally, industrial machines such as printing presses and assembly lines are reconfigured for the job at hand, whether that is a new print run or a new automobile model. As critical as these machines are to an organization's earnings, the operators tend to know their machines, not the computing backbone necessary to run them. This can be problematic since these machines can be among an organization's biggest investments—and if they stop working, the organization stops earning money. Ultimately it would be desirable to have access to a software infrastructure that allows the organizations or device manufacturers to build solutions that provide the ability to modify settings in real time and add new feature sets to improve productivity automatically.

Solving all of these diverse and complex configuration and communication requirements has previously involved a device-by-device, network-by-network, and location-by-location manual configuration. For example, if a business traveler is traveling throughout Europe, and wants to utilize the GPRS network (a high-speed data network) with a PDA, for example, he or she will need to know the local access numbers and communication protocols particular to each country, and in some cases, to different regions in each country. Thus, the traveler will need determine this information each time he or she changes location —a time-consuming task. Also, the traveler will typically have to manually and laboriously reconfigure the PDA each time he or she moves location. The ability to seamless communicate while traveling through different geographic regions is simply unavailable.

Similarly, when a business traveler travels from one office to another within a company, he or she may wish to utilize different user configurations and preferences for the different network topologies. For example, the business traveler may wish to use one particular email application for the home office, and another for a satellite office, with different address books and digital signatures for each. However, if the business traveler was using a portable communication device like a cell-phone or a PDA to communicate with each office, merely logging into a different network would not appropriately reconfigure the communication device, or automatically change the user's preferences. Again, the business traveler would be forced to manually reconfigure the communication device each time he or she travels to a different office. If the business traveler has a number of portable computer devices, reconfiguring each device every time he or she changes offices could prove to be quite difficult, especially for a frequent traveler.

Given the above background, what is needed in the art are solutions that provide remote configuration of electronic devices based on changing device circumstances, such that end users do not have to manually reconfigure their devices every time a change occurs, and such that service providers can retain centralized control of configuration—and preference-setting of the devices.

### SUMMARY OF THE INVENTION

One embodiment of the present invention is a method of remotely modifying a current configuration of a portable computer device. The current configuration affects at least one function of the portable computer device. In particular, the method determines, at the portable computer device, a changed external circumstance. The method transmits an indication of the changed external circumstance, associated with the portable computer device, to a remote server.

Next, the method receives, at the remote server, the indication of the changed external circumstance associated with the portable computer device. Additionally, the method determines, from a computer database, a modified configuration appropriate to the portable computer device, based at least in part on the changed external circumstance associated with the portable computer device. Then, the method transmits the modified configuration from the remote server to the portable computer device, and receives, at the portable computer device, the modified configuration. Finally, the method updates the current configuration of the portable computer device with the modified configuration, which affects at least one function of the portable computer device.

Another embodiment of the present invention is a method of remotely configuring a portable electronic device based on a geographic location of the device. In this embodiment, the portable electronic device has an associated configuration affecting electronic communications of the device. The steps of the method occur at a remote system. At the remote system, the method receives the geographical location of the portable electronic device. The method then identifies, from a database, a set of preferences corresponding to the portable electronic device and to the geographic location of the portable electronic device. Finally, the method transmits the set of preferences to the portable electronic device; which modifies the associated configuration of the portable electronic device, thereby affecting the electronic communications of the portable electronic device.

Yet another embodiment of the present invention is a method of remotely configuring a portable electronic device based on the device communicating with a new network topology. In this embodiment, the portable electronic device has an associated configuration affecting at least one function of the portable electronic device. The steps of the method in this embodiment occur at a remote system, separate from the new network topology. The method first receives an indication of the new network topology in communication with the portable electronic device. Then, the method identifies, from a database, a set of preferences corresponding to the portable electronic device and to the new network topology in communication with the portable electronic device. Finally, the method transmits the set of preferences to the portable electronic device, which modifies the associated configuration of the portable electronic device, thereby affecting a subset of the at least one function of the portable electronic device.

An additional embodiment of the present invention is a database for storing configuration information for remote configuration of electronic devices. The database includes a plurality of unique electronic device identifiers, each of which correspond to at least one electronic device. The database also includes a plurality of sets of current configuration parameters, each of which are associated with one or more unique electronic identifiers. Each set of current configuration parameters represents the configuration of at least one function of the at least one electronic device corresponding to the associated one or more unique electronic identifiers. The database further includes one or more dynamic configuration parameters, each of which is associated with one or more changed device circumstances. The one or more changed device circumstances including at least one circumstance selected from the set consisting of: new geographic location, new network topology, new user, and new hardware addition.

### BRIEF DESCRIPTION OF THE DRAWINGS

Additional objects and features of the invention will be more readily apparent from the following detailed description and appended claims when taken in conjunction with the drawings, in which:

FIG. 1 illustrates a system of electronic devices in accordance with an embodiment of the present invention.

FIG. 2 illustrates an electronic device that is consistent with an embodiment of the present invention.

FIG. 3 illustrates an intermediate server that is consistent with an embodiment of the present invention.

FIG. 4 illustrates a DNA database in accordance with one embodiment of the present invention.

FIG. 5 illustrates a definitions database in accordance with one embodiment of the present invention.

FIG. 6 illustrates a flowchart of a user login for updating preferences in accordance with one embodiment of the present invention.

Like reference numerals refer to the same element throughout the several views of the drawings.

### DETAILED DESCRIPTION OF THE INVENTION

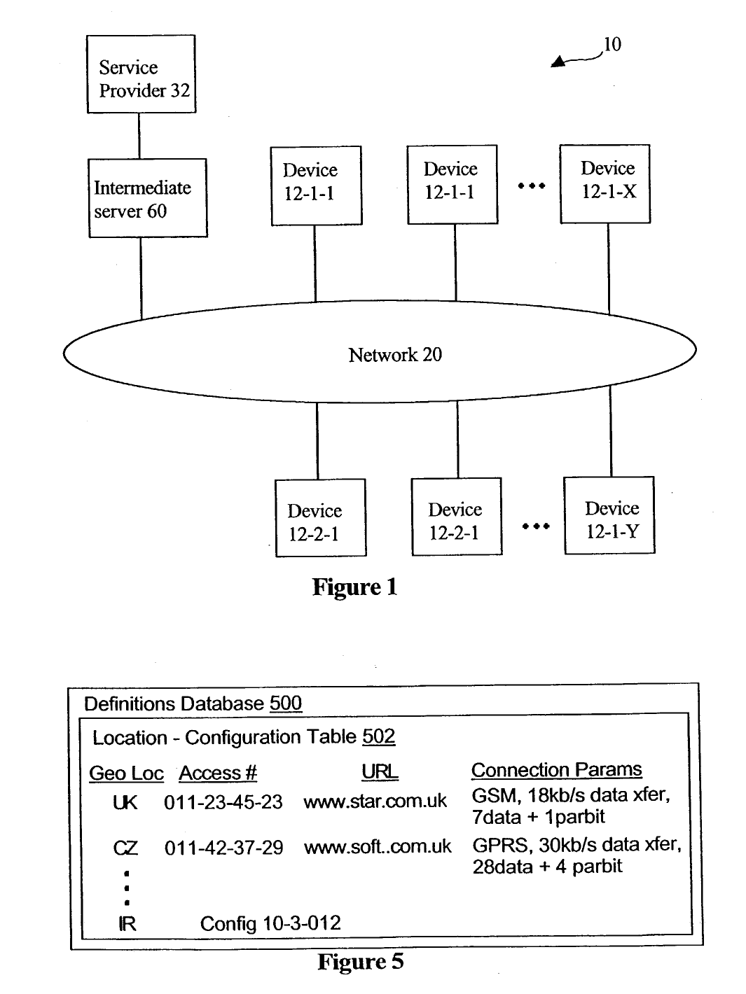

Referring to FIG. 1, there is shown a system 10 that is operated in accordance with one embodiment of the invention. System 10 includes a network 20, one or more electronic devices 12, an intermediate server 60, and a service provider 32. As illustrated in FIG. 1, each of the electronic devices 12 and the intermediate server 60 are connected to the network 20. The connection between the intermediate server 60 is typically a wireline connection (e.g., a connection comprising metallic wire conductors and/or optical fibers). The electronic devices 12 are not typified by any particular type of connection. The electronic devices 12 may be connected to the network 20 by a wireline connection and/or a wireless connection (e.g., a connection comprising electromagnetic waves such as RF, infrared, laser, visible light, and acoustic energy).

The precise technique used by the electronic devices 12 and the intermediate server 60 to establish a physical connection to the network 20, and thus each other 12, 60 is not critical to the present invention.

Service provider 32 is an electronic service such as an Internet service provider. Representative service providers 32 include, but are not limited to, Deutsche Telekom (Bonn Germany), Yahoo! (Sunnyvale, Calif.), AT&T Broadband (Denver, Colo.), Microsoft Network (Redmond, Wash.), Sprint (Kansas City, Mo.), FedEx Corporation (Memphis, Tenn.), and OnStar (http://Iwww.onstar.com/flash.html). A service provider 32 can provide access to services such as stock tracking programs, address programs, and accounting programs, through the electronic devices 12—as described in more detail below. A service provider 32 can also provide access to services such as Microsoft Exchange Server (Redmond, Wash.), Internet Message Access Protocol (IMAP) server, and the Lightweight Directory Access Protocol (LDAP) Server. LDAP is designed to run directly over a TCP/IP stack. (See http://www.kingsmountain.com/ldapRoadmap.shtml#background). An IMAP server provides a method of accessing electronic mail or bulletin board messages that are kept on a mail server that may or may not be shared (see http://www.imap.org).

Although the network topology shown in FIG. 1 illustrates a service provider 32 that is external to the intermediate server 60, the invention is not limited to this network topology. In some embodiments of the present invention, server provider 32 is a software module that is hosted by the intermediate server 60.

In embodiments in which a service provider 32 is not hosted by the intermediate server 60, the service provider 32 and the intermediate server 60 are connected by a communications network. In some embodiments, the communications network is a local area network (LAN), wide area network (WAN), metropolitan area network (MAN), an Intranet, the Internet, or any combination of such networks.

As described in more detail below, a service provider 32 and an electronic device 12 communicate through the intermediate server 60. Generally, communication of data between computers, and other types of devices, within a first network (e.g., network 20) and between computers, and other types of devices, in another network (e.g., the communications network connecting a service provider 32 and the intermediate server 60) is handled by a hierarchy of protocols each of which simplifies a stage in the communication process (see, for example, Computer Networks, A Systems Approach, Peterson, L. L. and Davie, B. S., Morgan Kaufmann, Inc., 1996, incorporated herein by reference).

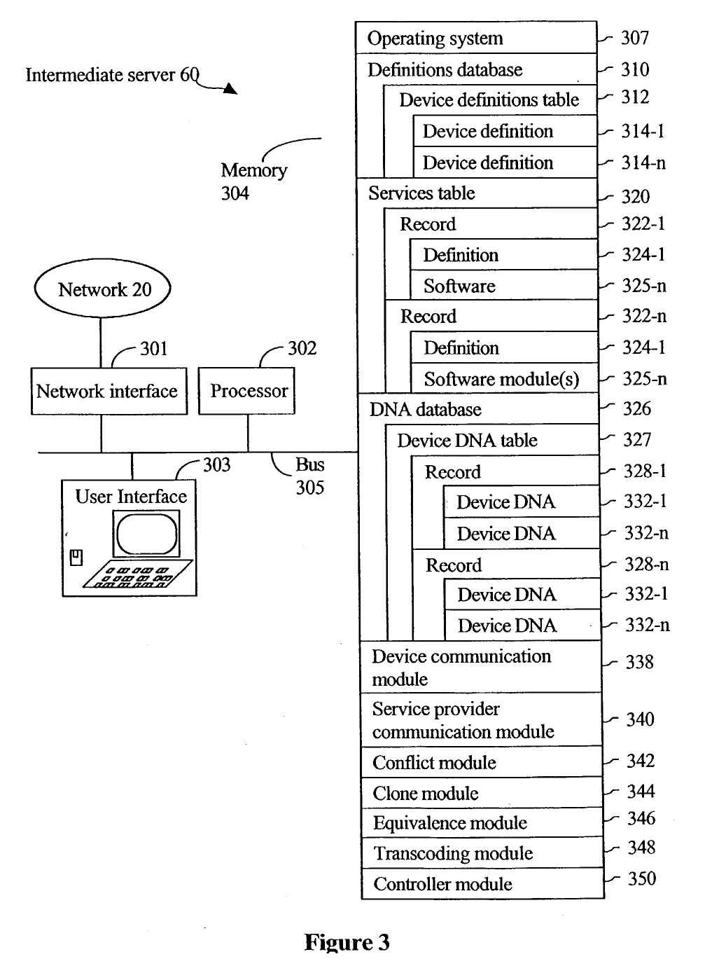

The service provider 32 typically creates an account for each user (e.g., corporate entity or individual) who uses the services provided by the service provider 32. The account typically specifies information such as usernames and passwords, authorized users, and service subscriptions (e.g., a given account may provide access to only a subset of the services provided by a given service provider 32). An account preferably specifies one or more electronic devices 12 that may be used in conjunction with the account. For example, a given account may indicate that a PDA and a cell phone (two types of electronic devices 12) may be used to access services provided by the service provider 32 (through the intermediate server 60). The account preferably includes, therefore, information that can be used to identify and/or contact an electronic device 12 (e.g., a telephone number of a cell phone) corresponding to the account. Additionally, the service provider 32 preferably provides a means for modifying the account. For example, a web based interface may be provided to enable a user to add, remove, or modify one or more services and electronic devices 12 corresponding to the account. Additionally, an electronic device 12 may be configured to access only a subset of services otherwise available to or through a corresponding account. As described in more detail below, this account information is passed on to the intermediate server 60, which incorporates this information into a device DNA table 327 (FIG. 3).

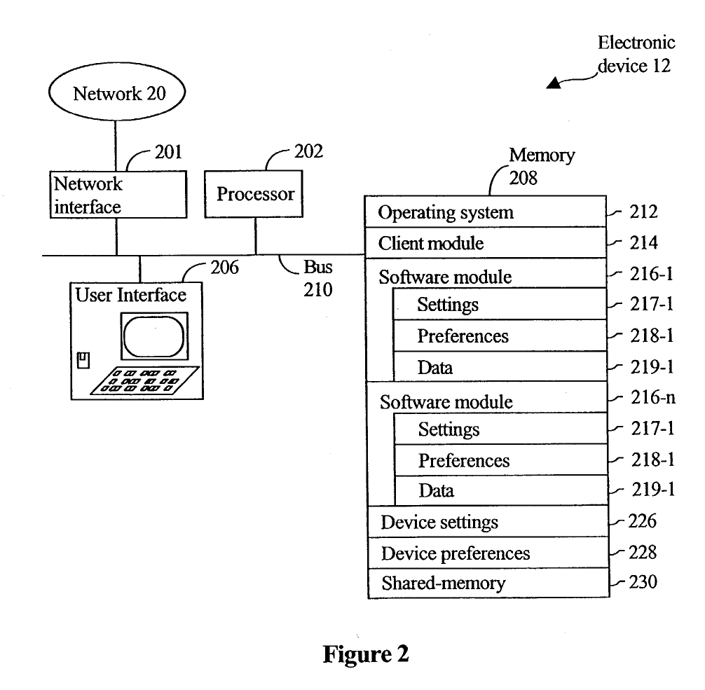

As illustrated in FIG. 2, an electronic device 12 typically includes the following components: a network interface 201, a processor 202, a user interface 206, a memory 208, and a bus 210, which interconnects the aforementioned components. The network interface 201 couples the electronic device 12 to the network 20. The precise structure of this component is governed by how the electronic device 12 communicates with the network 20 (e.g., wireless or wireline). The processor 202 executes various software modules maintained in the memory 208 as described in more detail below. The user interface 206 enables a user to interact with the electronic device 12 and typically includes components such as a keyboard, touch pad screen/display, microphone, and speakers.

The memory 208, which typically includes high speed random access memory as well as non-volatile storage such as disk storage, stores an operating system 212, a client module 214, one or more software modules 216, device settings 226, device preferences 228, and shared-memory 230.

The operating system 212 includes procedures for handling various basic system services and for performing hardware dependent tasks. The operating system 212 also provides software modules 214, 216 with access to system resources, such as the memory 208 and the user interface 206.

The client module 214 enables the intermediate server 60 to manage the electronic device 12. More specifically, the client module 214 can receive and process data from the intermediate server 60. For example, the intermediate server 60 may transmit over the network 20 a software module, and an instruction to install the software module, to the electronic device 12. The client module 214, in communication with the intermediate server 60, may then receive and initiate installation of the software module. The client module 214 also preferably has access to the shared-memory 230, device preferences 228, device settings, and software modules 216, including the settings 217, preferences 218, and data 219 of the software modules 216. Accordingly, the client module 214 is typically capable of modifying, adding, or deleting all or some aspect of each. The client module 214 may also transmit some or all of the device preferences 228, device settings, and software modules 216, including the settings 217, preferences 218, and data 219 of the software module's 216 to the intermediate server 60 and/or a service provider 32. The client module 214, moreover, may also transmit information about items including the device preferences 228, device settings, and software modules 216, including the settings 217, preferences 218, and data 219 of the software modules 216 without actually transmitting these items. For example, the client module 214 may only indicate that a change has been made to an aspect of a corresponding electronic device 12.

The client module 214 preferably communicates with the intermediate server 60 using an efficient protocol. In particular, the protocol preferably operates effectively over both wireless and wireline networks, is adaptable to the capabilities of each type of electronic device 12 described herein, and supports a wide variety of transport protocols. In some embodiments of the present invention, the client module 214 comprises a SyncML stack (see, for example, http://www.syncml.org).

The software modules 216 include all manner of software modules installed on electronic devices 12. An exemplary software module 12 is a e-mail program. E-mail programs in general include settings 217, preferences 218, and data 219. Settings 217 and preferences 218 are similar concepts and include, for example, limitations on the size of a corresponding address book and interface preferences. As indicated above, the data 219 may comprise an address book or other information.

The device settings 226 may control how the electronic device 12 interacts with the network 20. Each of the software modules 216, therefore, access the network 20 in a manner defined by the device settings 226. Similarly, the device preferences 228 may preselect certain options when such options are presented to the electronic device 12. For example, when a software module 216 is being installed, it may default to a particular language as defined by the device preferences 228.

The shared-memory 230 may be used by the software modules 216, operating system 212, and/or the client module 214 to store information independently or under the direction of a user. For example, a service provided by a service provider 32 may including backing up some or all of the shared memory 230 (e.g., a subdirectory of a file system).

Persons skilled in the art recognize that the precise make up of the electronic device 12 depends upon its nature. For example, some electronic devices 12 are more complex than others. The more complex a electronic device is, the more likely it is that the electronic device 12 includes components not found in more simplistic electronic devices 12. Generally, all that is required by the present invention is a means for communicating with the intermediate server 60 (e.g., access to the network 20), elements manageable by the intermediate server 60 (e.g., device settings 226), and a means for managing the manageable elements (e.g., client module 214). The range of electronic devices 12 includes but is not limited to handheld computers, laptops, switches, routers, appliances, wearable computers, personal digital assistants, cellular telephones, pagers, electronic note-pads, palm-top computers, e-books, smart-cards, cameras, dicta phones, heart-rate monitors, cycle computers, pedometers, wristwatch computers, GPS devices, electronic toys, games, or other amusement devices, and home security controllers.

As illustrated in FIG. 3, the intermediate server 60 includes standard server components including a network interface 301 for coupling intermediate server 60 to other devices via network 20, a processor 302 for executing various software modules maintained in a memory 304, an optional user interface 303 (e.g., keyboard, mouse, and display), the memory 304, and a bus 305 for interconnecting the aforementioned components.

The memory 304, which typically includes high speed random access memory as well as non-volatile storage such as disk storage, stores a number of software modules and data structures that are used in accordance with the present invention. In a typical embodiment, the memory 304 includes an operating system 307, which generally comprises procedures for handling various basic system services and for performing hardware dependent tasks, a definitions database 310, a services table 320, a DNA database 326, a device communication module 338, a service provider communication module 340, a conflict module 342, a clone module 344, an equivalence module 346, a transcoding module 348, and a controller module 350.

The definitions database 310 preferably includes at least a device definitions table 312, which describes electronic devices 12 in detail. More specifically, the device definitions table 312 comprises a record 314 for each of the electronic devices 12 with which the intermediate server 60 may communicate. The records 314 preferably include fixed hardware descriptions, removable hardware descriptions, and operating system (and/or other required software module) descriptions for the electronic devices 12. The records 314 also preferably include information such as typical device configurations, supported software modules, feature sets, and hardware limitations. For example, if a particular version of an electronic device 12 (e.g., a hand held computer) only has black and white displays, this fact is included in a corresponding device definition 314. As described in more detail below, each record 314 includes information that enables the creation of device DNA for a corresponding electronic device 12. The device definitions table 312 is preferably updated as new electronic devices 12 become available.

The services table 320 comprises a plurality of records 322 for each service offered by a service provider 32. Each of the plurality of records 322 preferably include a sub-record 324 with a definition of (e.g., information about) a corresponding service and a sub-record 325 with one or more software modules used in conjunction with the corresponding service. The definition sub-record 324 preferably includes, but is not limited to, a description of the service, a list of services or software modules with which the service conflicts, authentication requirements for using the service, device hardware requirements of the service, and software module requirements of the service. Memory usage and processor speed requirements, for example, may be included the definition. The software module(s) sub-record 325 includes each software module that may be required by a corresponding service. In other words, the software module(s) sub-record 325 includes software modules such as e-mail programs, games, dynamic link libraries, and virtual machines and software modules such as patches and/or upgrades that modify other software modules. The services table 320 is preferably created and/or updated as information (e.g., definitions and software modules) becomes available.

The DNA database 326 includes one or more tables storing DNA. In particular, the DNA database 326 includes a device DNA table 327, which stores device DNA for each electronic device 12 that may interact with the intermediate server 60. More specifically, the device DNA table 327 includes a record 328 for each account created by the service provider 32 and forwarded to the intermediate server 60 as described above. Each of these records 328 includes a sub-record 332 for each electronic device 12 corresponding to the account. Included in a sub-record 332 is device DNA for a corresponding electronic device 12. For example, device DNA for a given electronic device 12 typically includes: a fixed hardware description, a removable hardware description (including whether a given removable hardware component was ever attached), a list of software modules installed on the electronic device 12, software module settings and preferences, a description of the data for each of the software modules (but preferably not the data itself), data source settings, a list of users who can use the electronic device 12, the device specific configuration for each service available through the electronic device 12 (e.g., the location of an e-mail server), and device specific mappings of data sources (e.g., which address book entries are stored on which device for a specific user). Descriptions of the data typically identify when the data was last changed, periods in which the data did not change, how many entries are included in the data (in the case of a list or database), the size of the data, and/or a general description of the data. The sub-record, moreover, may include any corresponding information found in the definitions database 310 and the services table 320. To be clear, there is a one to one correspondence between each electronic device 12 in the system 10 and corresponding device DNA maintained in a record 332.

As described in detail below, device DNA may be uploaded to the intermediate server 60 from electronic devices 12 in order to update a corresponding device DNA entry 332. Additionally, an update of the device DNA may be triggered by the service provider 32 When, for example, a user adds or removes a service accessible through one or more Electronic devices 12 corresponding to the user's account. The device DNA of a given Account may also be modified in a manner that corresponds to changes made to another Device DNA corresponding to a common account.

As noted above, the data itself is preferably not included in the device DNA. Instead, the data is maintained and/or backed-up, if at all, by the service provider 32. So when the intermediate server 60 copies data from one electronic device 12 to another (as described in detail below), the data is typically obtained from a service provider 32. This does not exclude, however, including, for example, device settings 226 in device DNA.

Again, the service provider 32 typically provides a defined number of services. Additionally, an electronic device 12 may include software modules and data unrelated to the services provided by a service provider 32. In preferred embodiments of the present invention, information pertaining to such software modules and data is not included in the device DNA. Instead, such information is preferably excluded entirely from the device DNA or included only to the extent that it affects software modules, data, etc., corresponding to a service provided by a service provider 32. For example, if the services table 320 indicates that a first software module (e.g., a software module not included in the services table 320) conflicts with a second software module (e.g., a software module included in the services table 320), the device DNA may reflect that the first software module is installed on a corresponding electronic device 12 to avoid conflicts.

Moving on to another element of FIG. 3, the service provider communication module 42 communicates with a service provider 32. The protocol that the service provider communication module 42 uses to communicate with a service provider 32 depends upon the exact specifications of the service provider 32. Typically, however, the service provider communication module 42 employs one or more open web standards known in the art to communicate with a service provider 32.

The device communication module 46 communicates with electronic devices 12. Device communication module 46 works in conjunction with the controller module 350 (described below) and the device DNA table 327 in order to accomplish this task. More specifically, the device communication module 46 uses the information in the device DNA table 327 to customize communication with a respective electronic device 12. For example, the device communication module 46 uses the information in the device DNA table 327 to select a protocol that is most efficient given the characteristics of the respective electronic device 12.

The conflict module 342 is designed to avoid conflicts concerning software modules that are, or may be, installed on an electronic device 12. As indicated above, the services table 320 defines software modules needed to provide a particular service and defines dependencies and conflicts between services, between services and software modules, and between services and hardware components (e.g., the size of memory 208). Using this information, in conjunction with device DNA, the conflict module 342 determines whether a software module to be installed on an electronic device 12 will operate successfully. If not, the conflict module 342 modifies the device DNA such that this software module is not installed until the conflict module 342 determines that the software module will operate successfully. A change in such a determination usually results from software and/or hardware changes on the corresponding electronic device 12 (e.g., a conflicting software module is removed and/or memory 208 is expanded).

The clone module 344 is designed to make services (e.g., data, preferences, settings, software modules) available on an old electronic device 12 available on a new electronic device 12. More specifically, the clone module 344 migrates the device DNA of the old electronic device 12 into a new device DNA entry 332 (typically corresponding to the same account record 328). As described in more detail below, the next time the new electronic device 12 connects to the intermediate server 60, any software modules, settings, preferences, and/or data defined by the new device DNA entry 332 are downloaded to the new electronic device 12 (in what may be termed a bootstrap process). Note that the device DNA is not typically an exact copy since information such as device identification usually must be unique; but the services provided by corresponding electronic devices 12 usually are identical. The clone module 344 is typically employed when a user upgrades to a new electronic device 12, when a user acquires a second electronic device 12, and when an existing electronic device 12 is lost and replaced.

The equivalence module 346 is designed to identify means for providing access to services through a given electronic device 12 that is equivalent to access to services that is not otherwise available through the electronic device 12. Typically, a service provider 32 provides services that can only be accessed by specific software modules installed on an electronic device 12. More specifically, a first software module may be used by a first electronic device 12 to provide access to a service; whereas a second software module may be used by a second electronic device 12 to provide access to the same service. This is usually the result of limitations found in the first electronic device 12, but not in the second electronic device 12. For example, e-mail service on a cell phone and a PDA (two types of electronic devices 12) may be provided by different software modules and include different feature sets, but access the same e-mail account. In other words, the access to the e-mail account is not equivalent on the respective electronic devices 12. Another example is a word processing software module operating on a relatively robust electronic device 12. Less robust electronic devices 12 (e.g., electronic devices 12 with less memory 208) may not be able to run the same word processing software module. Instead, the less robust electronic device 12 may operate a less demanding word processing software module—with a correspondingly limited set of features. In other words, the two electronic devices 12 do not provide the same access to an idealized word processing software module.

The equivalence module 346 is typically engaged when a first electronic device 12 is modified to provide access to a service provided by service provider 32. The equivalence module 346 identifies software modules needed to provide equivalent access to the service on one or more other corresponding electronic devices 12 (e.g., electronic devices 12 corresponding to a common account). The equivalence module 346 then uses these identifications to modify the device DNA corresponding to the one or more other corresponding electronic devices 12. As described in more detail below, the next time the one or more other corresponding electronic devices 12 connect to the intermediate server 60, any software modules, settings, preferences, and/or data defined by the modified device DNA entry are downloaded to the one or more other corresponding electronic devices 12. The one or more other corresponding electronic devices 12 may then be capable of providing the same or equivalent access to the service.

The transcoding module 348 is designed to provide a plurality of views of data to match the capabilities of different electronic devices 12. For example, on an electronic device 12 with limited memory 208, only contacts of a contact list that have been accessed within a predefined period of time are transmitted to and stored by the electronic device 12. In this situation, the transcoding module 348 filters contact information sent to this electronic device 12. More specifically, control information is stored in the device DNA of an electronic device 12. The control information defines the view of information required by a corresponding electronic device 12. Each time this electronic device 12 accesses a particular service, the control information (e.g., the device DNA) is used by the transcoding module 348 to identify data items from a data source stored by a corresponding electronic device and the format of the data item's. For example, a particular data item may comprise three fields one a first electronic device 12, but one field on a second electronic device 12. The transcoding module 348 detects this fact and takes appropriate steps to transform the data as it is transmitted back and forth between the electronic devices 12 and between electronic devices 12.

To clarify, take the example of two electronic devices 12 operating different word processing software modules cited above with respect to the equivalence module 346. Because one word processing software module may not be able to process, for example, certain style sheets supported by the other word processing software module, the transcoding module 348 may allow transmission of a document created on the robust electronic device 12 only after the document has been saved to a version supported by the word processing software module running on the less robust electronic device 12. In other words, the transcoding module controls the view of the document by reference to device DNA.

The controller module 350 typically orchestrates the activities of the various modules described above. The controller module 350 also executes tasks not allocated to any of the various modules described above.

A general description of the electronic devices 12, a service provider 32, and the intermediate server 60 has been provided. Attention now turns to a more detailed description of processing steps taken in a preferred embodiment of the present invention.

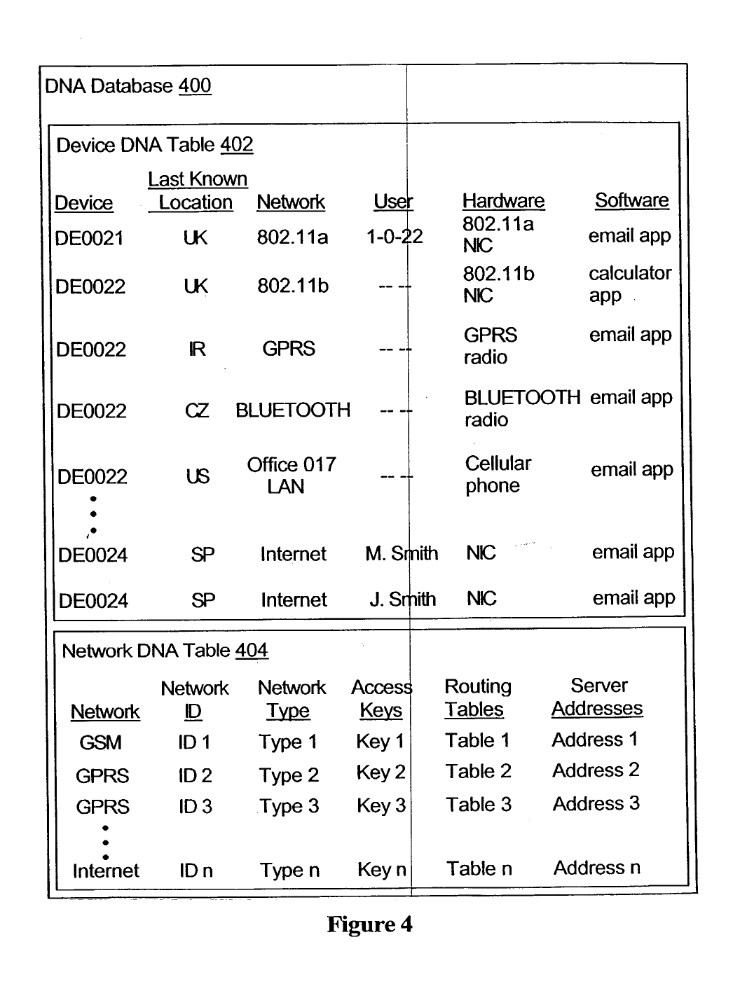

As shown in FIG. 4, DNA database 400 is a database of tables, or records, that stores some of the current configurations and preferences of devices managed by intermediate server 60 (e.g., “device DNA”), and stores current associated configuration information for various types of networks (“network DNA”). DNA database has at least two separate types of tables—device DNA table 402 and network DNA table 404. DNA database 400 is an exemplary embodiment of a subset of DNA database 326 and, in particular, demonstrates the type of information that intermediate server 60 can use to remotely configure electronic devices 12.

Device DNA table 402 includes a plurality of fields, such as Device, Last Known Location, Network, User, Hardware, and Software fields. These fields are generally associated with a particular device, identified in the Device field by a device designation, also known as an unique electronic device identifier, which may take the form of any designating sequence unique to that device. For example, a designating sequence could be an alphanumeric sequence. The other fields corresponding to a particular device may be the last known values for the particular field (e.g., Last Known Location), or they may be user- or intermediate-server-established configuration values for that particular device.

The Last Known Location field contains a designation denoting the last known location where the device was used to access intermediate server 60. This location information may be provided to the intermediate server 60 directly from an electronic device if, for example, the device contains a Global Position System (GPS) receiver, or if a user manually inputs geographic location information into the device. Alternatively, the intermediate server 60 can derive the information by identifying which network a device is communicating through —for example, by using well-known triangulation techniques or cellular-tower proximity information to determine where a cellular phone is transmitting from. The particular means by which the intermediate server 60 derives the geographical device is not meant to be limited to any particular method, and indeed, any method to determine geographical location is expressly contemplated to be within the scope of the invention. The actual location information may be stored in many different formats. For example, the Last Known Location information could be a code that identifies a country, as shown in FIG. 4 (e.g., “UK” designates the United Kingdom). Alternatively, the designation may be actual geographical coordinates or any, other designation that represents a location.

The Network field contains a designation (e.g., an indication) denoting the network used by a particular device. The designation is not necessarily determined by the device or the last known location. Examples of networks that may be utilized by electronic devices are BLUETOOTH, GSM, GPRS, Office 017 LAN, Internet, 802.11a, 802.11b, and 3G. The Network field can be used to access a specific network DNA entry, as stored in Network DNA Table 402 (discussed below), to determine configuration information for that network, and to configure electronic devices (or even controller devices on the network) accordingly.

The User field contains a designation denoting the user of a device, whether the last user to use the device, or a listing of all authorized users for the device. There may be more than one user for a single device. For example, a user M. Smith may share a device with a user J. Smith, such as device DE0024 as shown in FIG. 4, and it may be advantageous to store device DNA for both users, as each user may have different settings and preferences for the same device. This way, whichever user logs on, intermediate server 60 can configure the user's electronic device 12 accordingly, using the device DNA for the appropriate user.

The Hardware field indicates, for example, the means by which an electronic device 12 communicates with a network (e.g., NIC or BLUETOOTH radio), or it may also indicate any external hardware which is attached to a device. Certain hardware designations may be valuable for using the device in a given location or for a given network. For example, GPRS radio will facilitate connection to GPRS network. The Software field contains a designation denoting software modules associated with the device. In addition, there may be other fields in device DNA table 402 pertinent to device management and configuration (not shown).

Also shown in FIG. 4 is an exemplary network DNA table 404. As will be explained further below, this table can provide new configuration information for a device, if the device is utilizing a new network topology. Network DNA table 404 has a plurality of fields concerning network configurations, including Network, Network ID, Network Type, Access Keys, Routing Tables, and Server Addresses. The Network field includes a possible network to which devices may connect. An example of a network commonly used in Europe is GSM. Other networks include 802.11a, 802.11b, GPRS, BLUETOOTH, Office 017 LAN, and Internet. The Network ID field includes a designation of the identifier of the network listed in the network field. The Network Type field includes a designation of the network type, also known as network topology, for the network designation in the network field. An example of a network type is Ethernet. The Access Keys field designates an access key that may be used to access a part of the network. The Routing Tables field designates a matrix associated with a network control protocol, which gives the hierarchy of link routing at each node of a network. The Server Addresses field designates the addresses of servers on a network.

Illustrated in FIG. 5 is definitions database 500, including location-configuration table 502. Location-configuration table 502 is, in one embodiment, an association table, which allows intermediate server to reconfigure an electronic device if it has changed geographic location, explained in further detail below. By referencing the location-configuration table 502, intermediate server 60 can determine new communication protocols, parameters, and user preferences particular to the new location. Location-configuration table 502 has a plurality of fields, including Geo Loc, Access #, URL, and Connection Params. The Geo Loc field contains a designation denoting a location. The Geo Loc field indicates a particular geographical region, such as a country as shown (e.g., “UK), or it may also be geographical coordinates or sets of coordinates. The Access # field contains some form of network access designation. For example, the Access # field designation could be a phone number for a location network service provider. The URL field contains a URL designation. The URL field could contain a “WWW” designation or any other addressing designation. The Connection Params field includes the parameters required to make a connection to a network, such as data transfer rate, communication protocol, etc.

The databases illustrated in FIGS. 4 and 5 are useful in a system for establishing preferences for communication devices. For example, if the user of a device utilizes the device in multiple geographic locations, each of which requires different access configurations, these table can be used to remotely and automatically configure the device appropriately when the user attempts to login to a network. Or, if other external or device circumstances have changed for a particular device (e.g., new user, new network topology, the addition of new hardware, etc.), the tables in FIGS. 4 and 5 can be accessed to determine the appropriate configuration information (also called the modified configuration, or set of preferences) to apply to the device.

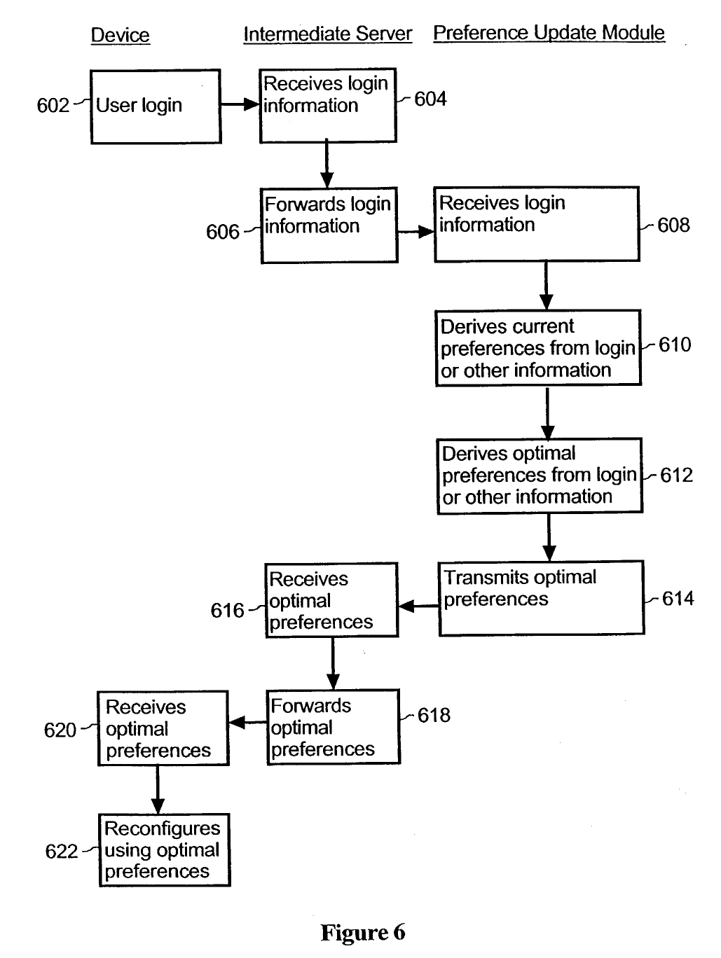

FIG. 6 illustrates a method to remotely modify a current configuration of an electronic device (also referred to as remotely configuring an electronic device), in accordance with one embodiment of the present invention. First, the user logs in to intermediate server 60 using device 12 in a system 10 (602). As part of the login process, electronic device 12 transmits login or status information to the intermediate server (also known as a remote server), which may include a changed external circumstance, such as a new geographical location or new user. The types of external circumstances detected and transmitted by the electronic device can be virtually any condition or state, and the invention is not meant to be limited to the specific examples previously discussed, as any changed device circumstance could be utilized. In general, such changes preferably correspond to a database entry in one of the fields of the databases illustrated in FIGS. 4 and 5. In one embodiment, the device sends an indication of a changed external circumstance only when it determines that an external circumstances has actually changed. In another embodiment, an electronic device will always transmit certain circumstances to the intermediate server on login, such as geographical location.

Next, the intermediate server receives the login information, which may include an indication of a changed external circumstance, such as a new geographical location (604), and forwards the login information to a preference update module (606). The preference update module that receives the login information (608). The preference update module is not separately illustrated in the figures, but its functionality can be provided by one of the modules shown in FIG. 3, such as the controller module 350, or it could be located on another server altogether. Next, in accordance with one embodiment, the preference update module derives the current preferences for the device, such as through the device DNA table 402 shown in FIG. 4 (610). The preference update module can compare the received login information, or other communication data provided by the intermediate server, against the current preferences stored in device DNA table 402 to determine whether a circumstance has changed. If a circumstance has changed, the preference update module will derive the optimal preferences for the device, depending on what circumstance and/or preference have changed (612). The preferences update module may do this by referencing an association table in a database, such as the location-configuration table 502.

For example, if the geographical location has changed for a device, e.g., the received geographical information is different than the geographical location stored in the Last Known Loc field for that device (shown in FIG. 4), then the preference update module refers to the location-configuration table 502 to determine the modified configuration information for the new location. Thus, a business traveler may have just changed countries in Europe, and may need the new telephone access numbers and communication parameters to continue to use a particular network. This information should be stored in location-configuration table 502.

As another example, an associated user field may be found in a device DNA table 402. Fields associated with the user, such as last known location, network, hardware, or software can indicate possible optimal preferences. A location may have an optimal access number, URL, or connection parameters associated with it stored in a location-configuration table 502. A network may have optimal network ID, network type, access keys, routing tables, and server addresses associated with it stored in a network DNA table 404. The optimal preferences may simply be modified configurations. Tile use of the term optimal does not necessarily imply that the optimal preferences are superior to other preferences.

In an alternative embodiment, the preferences update module will determine optimal preferences every time it receives an indication of a changed external circumstance. Or, in another embodiment, the preferences update module will always determine optimal preferences information based on the login information, without making a comparison between current preferences or circumstances and received preferences or circumstances.

The optimal preferences will typically affect a function of an electronic device, such as electronic communications. Thus, a typical preference may be communication protocols and network access numbers, as distinct from regional-based data content, for example. Such a reconfiguration may allow access to a network or use of specific hardware utilized in electronic communication.

The preference update module transmits the optimal preferences back to intermediate server (616). The intermediate server receives the optimal preferences (616), and forwards the optimal or modified preferences to the device (618). The device receives the optimal preferences (620) and reconfigures itself using optimal preferences (622). The reconfiguration is preferably transparent to the user. As described, the modified configuration may affect at least one function of the device, and may affect electronic communications of the device. For example, the configuration may include connection parameters necessary for access to a network with the device. In an alternate embodiment, the preference update module transmits the optimal preferences 614 directly to the device rather than through the intermediate server. In this alternate embodiment, steps 616 and 618 are skipped.

In practice, the electronic devices managed by intermediate server 60 are frequently only intermittently connected to a network. In this case, the intermediate server or preferences update module may store a record in a database indicating the optimal preferences are to be transmitted to an electronic device (such as a flag). Then, at a next intermittent communication between the device and the intermediate server, the intermediate server accesses the database, determines that the stored record indicates that the optimal parameters are to be transmitted, and transmits them to the device. Alternatively, the preferences update module may conduct this functionality.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A method of remotely modifying a current configuration of an electronic device, the current configuration affecting at least one function of the electronic device, the method comprising:
detecting, at the electronic device, a changed external circumstance;
transmitting an indication of the changed external circumstance, associated with the electronic device, to a remote server;
receiving, at the remote server, the indication of the changed external circumstance associated with the electronic device;
determining, from a computer database, a modified configuration appropriate to the electronic device, based at least in part on the changed external circumstance associated with the electronic device;
transmitting the modified configuration from the remote server to the electronic device;
receiving, at the electronic device, the modified configuration; and
updating the current configuration of the electronic device with the modified configuration;
wherein the modified configuration affects at least one function of the electronic device.

2. The method of claim 1, wherein the changed external circumstance is a new geographic location of the electronic device.

3. The method of claim 1, wherein the changed external circumstance is communication, by the electronic device, with a new network topology.

4. The method of claim 1, wherein the changed external circumstance is a new user of the electronic device.

5. The method of claim 1, wherein the changed external circumstance is an addition of new hardware to the electronic device.

6. The method of claim 1, wherein the modified configuration includes at least one configuration parameter selected from a set of configuration parameters including:
communication protocol, network data transmission speed, error checking, network access code, network access telephone number, network identifier, IP address, and a password.

7. A method of remotely configuring a portable electronic device based on a geographic location of the portable electronic device, the device having an associated configuration affecting electronic communications of the device, the method comprising:
at a remote system:
receiving the geographical location of the portable electronic device;
identifying, from a database, a set of preferences corresponding to the portable electronic device and to the geographic location of the portable electronic device; and
transmitting the set of preferences to the portable electronic device;
wherein the set of preferences modifies the associated configuration of the portable electronic device, thereby affecting the electronic communications of the portable electronic device.

8. The method of claim 7, wherein the identifying further comprises:
determining whether the received geographical location is different than a stored geographical location, associated with the portable electronic device, in a database; and
if the received geographical location and the stored geographical location are different, identifying, from the database, a set of preferences corresponding to the portable electronic device and to the geographic location of the portable electronic device.

9. The method of claim 8, further comprising storing the received geographical location in the database, associated with the portable electronic device;

10. The method of claim 7, wherein the set of preferences includes at least one preference selected from the set consisting of: communication protocol, network data transmission speed, error checking, network access code, network access telephone number, IP address, and a password.

11. The method of claim 7, wherein the geographical location of the portable electronic device is provided to the remote system by a network service provider capable of intermittently electronically communicating with the portable electronic device.

12. The method of claim 11, wherein the transmitting further comprises:
storing a record in the database indicating that the set of preferences is to be transmitted to the portable electronic device;
determining, at a next intermittent electronic communication between the network service provider and the portable electronic device, that the stored record indicates that the set of preferences is to be transmitted; and
transmitting, during the next intermittent electronic communication, the set of preferences to the portable electronic device.

13. The method of claim 7, wherein the receiving and identifying comprise:
receiving the geographical location of the portable electronic device, and a new network topology in communication with the portable electronic device; and
identifying, from a database, a set of preferences corresponding to at least one of: the portable electronic device, the geographic location of the portable electronic device, and the new network topology in communication with the portable electronic device.

14. The method of claim 7, wherein the receiving and identifying comprise:
receiving the geographical location of the portable electronic device, and an indication of a new user of the portable electronic device; and
identifying, from a database, a set of preferences corresponding to at least one of: the portable electronic device, the geographic location of the portable electronic device, and the new user of the portable electronic device.

15. The method of claim 7, wherein the receiving and identifying comprise:
receiving the geographical location of the portable electronic device, and an indication of an addition of new hardware to the portable electronic device; and
identifying, from a database, a set of preferences corresponding to at least one of: the portable electronic device, the geographic location of the portable electronic device, and the new hardware added to the portable electronic device.

16. A method of remotely configuring a portable electronic device based on the portable electronic device communicating with a new network topology, the device having an associated configuration affecting at least one function of the portable electronic device, the method comprising:
at a remote system separate from the new network topology:
receiving an indication of the new network topology in communication with the portable electronic device;
identifying, from a database, a set of preferences corresponding to the portable electronic device and to the new network topology in communication with the portable electronic device; and
transmitting the set of preferences to the portable electronic device;
wherein the set of preferences modifies the associated configuration of the portable electronic device, thereby affecting a subset of the at least one function of the portable electronic device.

17. A database for storing configuration information for remote configuration of electronic devices, the database comprising:
a plurality of unique electronic device identifiers, each unique electronic device identifier corresponding to at least one electronic device;
a plurality of sets of current configuration parameters, each set of current configuration parameters associated with one or more unique electronic identifiers, the set of current configuration parameters representing the configuration of at least one function of the at least one electronic device corresponding to the associated one or more unique electronic identifiers; and
one or more dynamic configuration parameters, each dynamic configuration parameter associated with one or more changed device circumstances, the one or more changed device circumstances including at least one circumstance selected from the set consisting of:
new geographic location;
new network topology;
new user; and
new hardware addition.

18. A computer program product for use in conjunction with a computer system, the computer system for remotely configuring a portable electronic device based on a geographic location of the portable electronic device, the device having an associated configuration affecting electronic communications of the device, the computer program product comprising:
at a remote system:
instructions for receiving the geographical location of the portable electronic device;
instructions for identifying, from a database, a set of preferences corresponding to the portable electronic device and to the geographic location of the portable electronic device; and
instructions for transmitting the set of preferences to the portable electronic device;
wherein the set of preferences modifies the associated configuration of the portable electronic device, thereby affecting the electronic communications of the portable electronic device.

19. The computer program product of claim 18, wherein the instructions for identifying further comprise:
instructions for determining whether the received geographical location is different than a stored geographical location, associated with the portable electronic device, in a database; and
if the received geographical location and the stored geographical location are different, instructions for identifying, from the database, a set of preferences corresponding to the portable electronic device and to the geographic location of the portable electronic device.

20. The computer program product of claim 19, further comprising instructions for storing the received geographical location in the database, associated with the portable electronic device.

21. The computer program product of claim 18, wherein the set of preferences includes at least one preference selected from the set consisting of: communication protocol, network data transmission speed, error checking, network access code, network access telephone number, IP address, and a password.

22. The computer program product of claim 18, wherein the geographical location of the portable electronic device is provided to the remote system by a network service provider capable of intermittently electronically communicating with the portable electronic device.

23. The computer program product of claim 22, wherein the instructions for transmitting further comprise:
instructions for storing a record in the database indicating that the set of preferences is to be transmitted to the portable electronic device;
instructions for determining, at a next intermittent electronic communication between the network service provider and the portable electronic device, that the stored record indicates that the set of preferences is to be transmitted; and
instructions for transmitting, during the next intermittent electronic communication, the set of preferences to the portable electronic device.

24. The computer program product of claim 18, wherein the instructions for receiving and identifying comprise:
instructions for receiving the geographical location of the portable electronic device, and a new network topology in communication with the portable electronic device; and
instructions for identifying, from a database, a set of preferences corresponding to at least one of: the portable electronic device, the geographic location of the portable electronic device, and the new network topology in communication with the portable electronic device.

25. The computer program product of claim 18, wherein the instructions for receiving and identifying comprise:
instructions for receiving the geographical location of the portable electronic device, and an indication of a new user of the portable electronic device; and
instructions for identifying, from a database, a set of preferences corresponding to at least one of: the portable electronic device, the geographic location of the portable electronic device, and the new user of the portable electronic device.

26. The computer program product of claim 18, wherein the instructions for receiving and identifying comprise:
instructions for receiving the geographical location of the portable electronic device, and an indication of an addition of new hardware to the portable electronic device; and
instructions for identifying, from a database, a set of preferences corresponding to at least one of: the portable electronic device, the geographic location of the portable electronic device, and the new hardware added to the portable electronic device.

27. A computer program product for use in conjunction with a computer system, the computer system for remotely configuring a portable electronic device based on the portable electronic device communicating with a new network topology, the device having an associated configuration affecting at least one function of the portable electronic device, the computer program product comprising:
at a remote system separate from the new network topology:
instructions for receiving an indication of the new network topology in communication with the portable electronic device;
instructions for identifying, from a database, a set of preferences corresponding to the portable electronic device and to the new network topology in communication with the portable electronic device; and
instructions for transmitting the set of preferences to the portable electronic device;
wherein the set of preferences modifies the associated configuration of the portable electronic device, thereby affecting a subset of the at least one function of the portable electronic device.
